(19) United States
(12) Patent Application Publication
(10) Pub. No.: US 2023/0125814 A1
(43) Pub. Date: Apr. 27, 2023

(54) CREDIT SCORE MANAGEMENT APPARATUS, CREDIT SCORE MANAGEMENT METHOD, AND COMPUTER READABLE RECORDING MEDIUM

(71) Applicant: NEC Corporation, Minato-ku, Tokyo (JP)

(72) Inventors: Kojiro HAMABE, Tokyo (JP); Masanori KOBAYASHI, Tokyo (JP)

(73) Assignee: NEC Corporation, Minato-ku, Tokyo (JP)

(21) Appl. No.: 17/910,593

(22) PCT Filed: Mar. 31, 2020
(86) PCT No.: PCT/JP2020/014745

§ 371 Date: Sep. 9, 2022

(51) Int. Cl. G06Q 40/03

(52) U.S. Cl. CPC G06Q 40/03

(57) ABSTRACT

A credit score management apparatus includes an acquisition unit for acquiring biometric authentication information of a credit score acquisition applicant, a storage unit for storing a credit score of a credit score acquirer and biometric authentication information of the credit score acquirer in association with each other; and a registration unit for registering the credit score acquisition applicant as the credit score acquirer in accordance with a result of comparison between the biometric authentication information of the credit score acquisition applicant and the biometric authentication information of the credit score acquirer.

### TECHNICAL FIELD

The invention relates to a credit score management apparatus and a credit score management method that manage credit scores, and further relates to a computer readable recording medium that includes a program for realizing these apparatus and method recorded thereon.

### BACKGROUND ART

A technique to allow a service provider and a service user to seek to ensure mutual trust with use of credit scores is disclosed in services based on, for example, consumer-to-consumer transactions (C2C), business-to-consumer transactions (B2C), government-to-consumer transactions (G2C), business-to-business transactions (B2B), and business-to-government transactions (B2G).

Also, as a related technique, Patent document 1 discloses an authentication system in which fraudulent activities cannot be easily conducted. According to the authentication system of Patent document 1, processing for authenticating whether a user is a pre-registered person is executed, and identification information of the user is output in a case where the user has been authenticated as a pre-registered, authenticated person. Then, based on this identification information, credit judgment is made with respect to the authenticated person, and the result of judgment is output. Credit judgment is made using information of the history of payment of past calling charges by the user, which is stored in registered authentication information, or a pre-set upper-limit price.

### LIST OF RELATED ART DOCUMENTS

### Patent Document

Patent document 1: Japanese Patent Laid-Open Publication No. 2005-032164

### SUMMARY OF INVENTION

### Technical Problems

However, with the above-described technique to secure reliability with use of credit scores, the reliability of credit scores cannot be sufficiently secured because a previous credit score cannot be reflected after a credit score acquirer (user) has cancelled the use of a credit score, or when he/she started the use of a credit score as another user while continuing the use of a credit score.

An example object of the invention is to provide a credit score management apparatus, a credit score management method, and a computer readable recording medium that improve the reliability of credit scores.

### Solution to the Problems

In order to achieve the example object described above, a credit score management apparatus according to an example aspect of the invention includes:
an acquisition unit configured to acquire biometric authentication information of a credit score acquisition applicant;
a storage unit configured to store a credit score of a credit score acquirer and biometric authentication information of the credit score acquirer in association with each other; and
a registration unit configured to register the credit score acquisition applicant as the credit score acquirer in accordance with a result of comparison between the biometric authentication information of the credit score acquisition applicant and the biometric authentication information of the credit score acquirer.

Also, in order to achieve the example object described above, a credit score management method according to an example aspect of the invention includes:
an acquisition step of acquiring biometric authentication information of a credit score acquisition applicant;
a storage step of storing a credit score of a credit score acquirer and biometric authentication information of the credit score acquirer in association with each other; and
a registration step of registering the credit score acquisition applicant as the credit score acquirer in accordance with a result of comparison between the biometric authentication information of the credit score acquisition applicant and the biometric authentication information of the credit score acquirer.

Furthermore, in order to achieve the example object described above, a computer-readable recording medium according to an example aspect of the invention includes a program recorded on the computer-readable recording medium, the program including instructions that cause the computer to carry out:
an acquisition step of acquiring biometric authentication information of a credit score acquisition applicant;
a storage step of storing a credit score of a credit score acquirer and biometric authentication information of the credit score acquirer in association with each other; and
a registration step of registering the credit score acquisition applicant as the credit score acquirer in accordance with a result of comparison between the biometric authentication information of the credit score acquisition applicant and the biometric authentication information of the credit score acquirer.

### Advantageous Effects of the Invention

As described above, according to the invention, it is possible to improve the reliability of credit scores.

### BRIEF DESCRIPTION OF THE DRAWINGS

FIG. 1 is a diagram for describing one example of a credit score management apparatus.

FIG. 2 is a diagram for describing one example of a system that includes a credit score management apparatus.

FIG. 3 is a diagram for describing a relationship between a credit score and a holding period.

FIG. 4 is a diagram for describing one example of the operation of the credit score management apparatus (registration).

FIG. 5 is a diagram for describing one example of the operation of the credit score management apparatus (holding).

FIG. 6 is a diagram for describing one example of the operation of the credit score management apparatus (notification).

FIG. 7 is a diagram for describing one example of a system of the example modification.

FIG. 8 is a block diagram for showing an example of a computer that realizes the credit score management apparatus.

### EXAMPLE EMBODIMENT

### Example Embodiment

The following describes an example embodiment of the invention with reference to the drawings. Note that in the drawings to be described below, the elements that have the same functions or corresponding functions are given the same reference sign, and a repetitive description thereof may be omitted.

### Apparatus Configuration

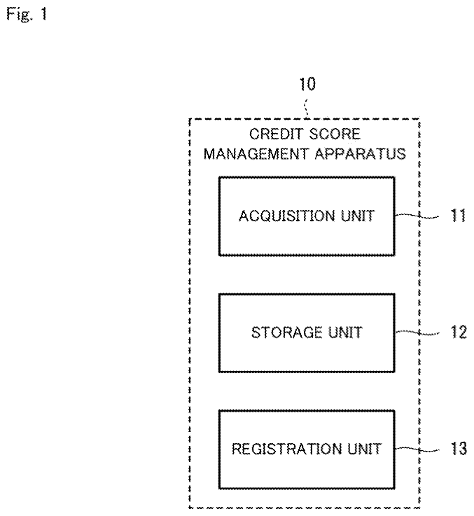

First, the configuration of a credit score management apparatus 10 in the example embodiment will be described using FIG. 1. FIG. 1 is a diagram for describing one example of a credit score management apparatus.

The credit score management apparatus 10 shown in FIG. 1 is an apparatus that manages credit scores of individuals and provide credit scores to individuals. Also, as shown in FIG. 1, the credit score management apparatus 10 includes an acquisition unit 11, a storage unit 12, and a registration unit 13.

Among these, the acquisition unit 11 acquires biometric authentication information of a credit score acquisition applicant. The storage unit 12 stores a credit score of a credit score acquirer and biometric authentication information of the credit score acquirer in association with each other. The registration unit 13 registers the credit score acquisition applicant as a credit score acquirer in accordance with the result of comparison between the biometric authentication information of the credit score acquisition applicant and biometric authentication information of credit score acquirers.

Biometric authentication information is, for example, information indicating a facial image of a credit score acquisition applicant or a credit score acquirer, the feature amount of this facial image, the features of a biological organ of a user other than the face (e.g., a fingerprint, an iris, a vein, or the like), the features of a behavior of a credit score acquisition applicant or a credit score acquirer, or the like. Note that two or more pieces of information that are included among the foregoing pieces of information may be used as biometric authentication information.

A credit score is an index indicating the creditworthiness of a person. A credit score is generated based on data of the record of use or provision of a service by a credit score acquirer. Credit scores are used in services of a variety of fields.

Services include, for example, a service that uses the sharing economy, a service related to a loan, a service related to an auction, and so on.

In the example embodiment, a credit score acquisition applicant is registered as a credit score acquirer in accordance with the result of comparison between biometric authentication information of the credit score acquisition applicant and biometric authentication information of credit score acquirers, and thus the reliability of credit scores can be improved.

### System Configuration

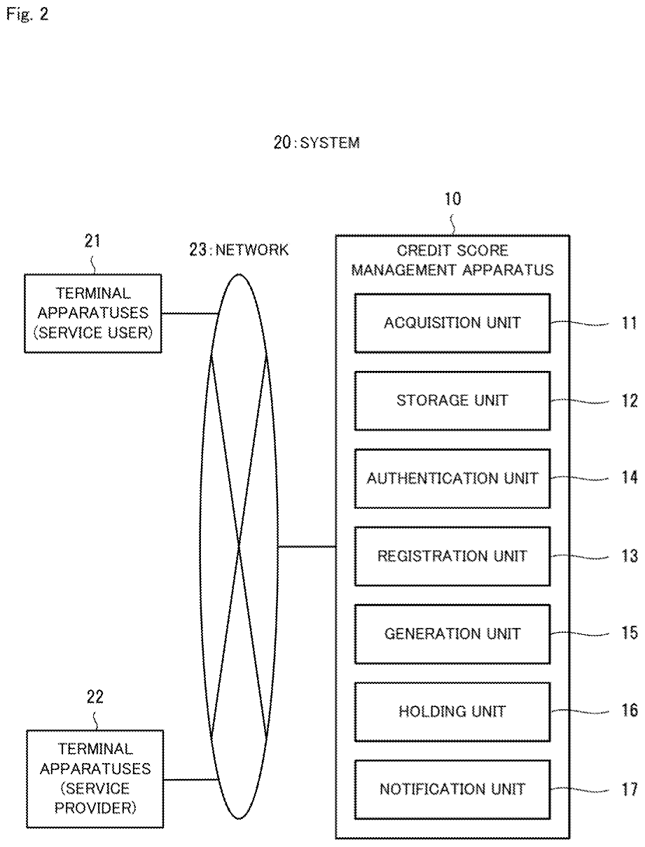

Next, the configuration of the credit score management apparatus 10 in the example embodiment will be described more specifically using FIG. 2. FIG. 2 is a diagram for describing one example of a system that includes a credit score management apparatus.

A system 20 in the example embodiment shown in FIG. 2 includes terminal apparatuses 21 and 22 and a network 23, in addition to the credit score management apparatus 10.

The terminal apparatuses 21 and 22 are terminal apparatuses owned by the individuals to whom credit scores are provided. The terminal apparatuses 21 and 22 are, for example, such information processing apparatuses as smartphones, tablets, personal computers, and special-purpose terminals.

In the example of FIG. 2, the terminal apparatus 21 is a terminal apparatus of a service user who holds a credit score. Also, the terminal apparatus 22 is a terminal apparatus of a service provider who holds a credit score.

The network 23 is a network via which the credit score management apparatus 10 and the terminal apparatuses 21 and 22 are connected. Also, a service mediation system (or a service mediation apparatus) that mediates services may be connected to the network 23.

The service mediation system is, for example, a system that mediates services of a variety of fields, such as a service that uses the sharing economy, a service related to a loan, and a service related to an auction.

A description is now given of the details of the credit score management apparatus.

The credit score management apparatus 10 includes the acquisition unit 11, the storage unit 12, the registration unit 13, an authentication unit 14, a generation unit 15, a holding unit 16, and a notification unit 17.

The credit score management apparatus 10 is, for example, an information processing apparatus, such as a computer, provided with a programmable device (e.g., a CPU (central processing unit), an FPGA (field-programmable gate array), or both of them). The credit score management apparatus 10 may be, for example, realized by a server computer or the like.

When an application for acquisition of a credit score is made, the acquisition unit 11 acquires biometric authentication information of a credit score acquisition applicant from the terminal apparatus 21 or 22 via the network 23.

The storage unit 12 stores a credit score of a credit score acquirer and biometric authentication information of the credit score acquirer in association with each other. Specifically, the storage unit 12 stores identification information (ID) for identifying a credit score acquirer, biometric authentication information of the credit score acquirer, and a credit score of the credit score acquirer in association with one another.

While the storage unit 12 is provided inside the credit score management apparatus 10 in the example of FIG. 2, it may be provided outside the credit score management apparatus 10. In this case, for example, a storage apparatus such as a database or a server computer is used as the storage unit 12.

Using the biometric authentication information of the credit score acquisition applicant acquired by the acquisition unit 11, the authentication unit 14 refers to pieces of biometric authentication information stored in the storage unit 12, which are respectively associated with credit score acquirers, and specifies a credit score acquirer. For example, an ID of a credit score acquirer is specified.

The registration unit 13 registers the credit score acquisition applicant as a new credit score acquirer in accordance with the result of comparison between the biometric authentication information of the credit score acquisition applicant and biometric authentication information of credit score acquirers.

The registration unit 13 compares the biometric authentication information of the credit score acquisition applicant with biometric authentication information of credit score acquirers.

In a case where the biometric authentication information of the credit score acquisition applicant has been registered as biometric authentication information of a credit score acquirer, the registration unit 13 does not register the credit score acquisition applicant as a new credit score acquirer.

Also, in a case where the biometric authentication information of the credit score acquisition applicant has been registered as biometric authentication information of a credit score acquirer, the registration unit 13 may register the credit score acquisition applicant as a credit score acquirer with a credit score of the registered credit score acquirer associated therewith. That is to say, in a case where a credit score acquirer has been specified, the registration unit 13 may register the credit score acquisition applicant as a new credit score acquirer, and also associate the new credit score acquirer with a credit score of the specified credit score acquirer.

The generation unit 15 inputs information (personal information) related to a credit score acquirer to a model, and generates a credit score of the credit score acquirer. Specifically, using data acquired from, for example, a company that holds personal information as an input, the generation unit 15 generates a credit score with use of a model generated by, for example, machine learning.

Conceivable examples of personal information (input parameter) include personal information such as the sex, age, academic background, and career, asset information such as deposits, shares, cars, and housing, credit information such as the history of purchase, loans, and the status of payment of public utility charges, interaction information such as the number and quality of friends and statements, behavior information such as purchased products, services that were used in the past, whether donations have been made, and the amount of donated money, information such as traffic violations, a criminal record, a judicial record, and the status of compensatory payment, and so forth.

In addition, personal information may also include, for example, the record of use of services (including evaluation scores provided by service providers), the record of provision of services (including evaluation scores provided by service users), and so forth. Furthermore, credit scores are updated as needed.

Note that while the generation unit 15 is provided inside the credit score management apparatus 10 in the example of FIG. 2, the generation unit 15 may be provided outside the credit score management apparatus 10. However, in a case where the generation unit 15 is provided outside, a configuration is adopted in which the same user is not allowed to generate a credit score by impersonating another user.

After the provision of a credit score has been cancelled, the holding unit 16 holds the credit score of a user who made the cancellation for a pre-set holding period.

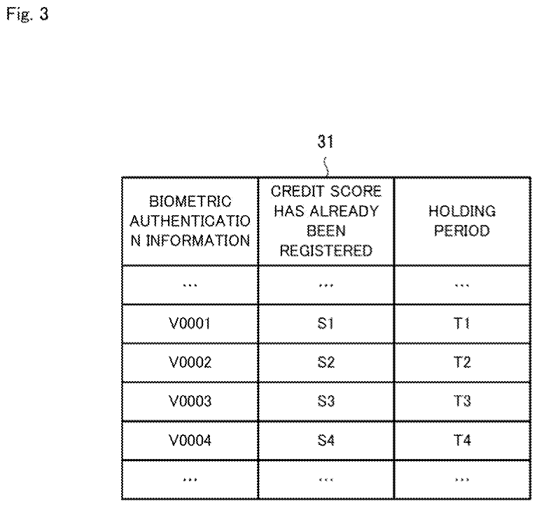

FIG. 3 is a diagram for describing a relationship between a credit score and a holding period. For example, as shown in FIG. 3, the storage unit 12 stores information indicating a holding period (. . . , “T1” to “T4”, . . . shown in table 31 of FIG. 3) in association with biometric authentication information.

Holding periods can be determined in advance based on, for example, terms of use of services. Holding periods may be the same, or may be set in accordance with, for example, personal information and credit scores of credit score acquirers. Note that in FIG. 3, identification information of credit score acquirers may be further stored in an associated manner.

Specifically, first, the holding unit 16 detects that the provision of a credit score has been cancelled. Subsequently, the holding unit 16 holds the credit score of the user (credit score acquirer) who made the cancellation for a pre-set period.

Also, in a case where a user who is the same as the user who made the cancellation has newly applied for acquisition of a credit score as a credit score acquisition applicant, the registration unit 13 does not register the credit score acquisition applicant as a new credit score registrant. That is to say, the credit score that has already been registered is continuously used.

Thereafter, in a case where the pre-set period has elapsed, the holding unit 16 deletes the credit score of the user who cancelled the provision of the credit score from the storage unit 12.

As described above, after the provision of a credit score is cancelled, the credit score of the user who made the cancellation is held for a pre-set period; thus, even if the user who made the cancellation applies again during the pre-set period, the held credit score is associated with the user who made the cancellation. As a result, the held credit score is continuously used, and the reliability of credit scores can be improved.

Note that in a case where a service business entity that deploys a service manages credit scores, cancellation of the service may be regarded as cancellation of a credit score. In this case, after a service accompanied by the provision of a credit score is cancelled, the holding unit 16 may hold a credit score of a credit score acquirer pertaining to the cancellation of the service for a pre-set period.

Also, in a case where a service business entity that deploys a service manages credit scores, when a pre-set period has elapsed since the cancellation of the service, the holding unit 16 deletes a credit score of a user who cancelled the service from the storage unit 12.

In a case where the biometric authentication information of a credit score acquisition applicant has been registered as biometric authentication information of a credit score acquirer, a first notification unit included in the notification unit 17 notifies the credit score acquisition applicant of the existence of a registered credit score (registration as the credit score acquirer).

That is to say, when application for request for management of a credit score is made, if a credit score has already been registered, the first notification unit included in the notification unit 17 makes notification to the terminal apparatus of the credit score acquisition applicant that the registered credit score is present. Note that when the terminal apparatus receives the notification, for example, a display indicating “there is a credit score that has already been registered” or the like is presented on a display of the terminal apparatus of the credit score acquisition applicant.

Notifying the credit score acquisition applicant in the foregoing manner enables the credit score acquisition applicant to understand that the credit score that has already been registered is continuously used or new registration is denied.

Also, when the service provider provides a service, or when the service user uses a service, the notification unit 17 notifies its partner or mediator (service mediation system) of the credit score.

For example, a display indicating “there is a credit score that has already been registered” or the like is presented on a screen of a display of the terminal apparatus 21 of the service user, the terminal apparatus 22 of the service provider, or both.

Also, when the service user uses the service, a second notification unit included in the notification unit 17 notifies the service user of the credit score held by the service provider. Specifically, first, the notification unit 17 acquires the credit score of the service provider from the storage unit 12.

For example, the service user makes a request for the provision of the credit score of the service provider when using the service. Based on this request, the notification unit 17 acquires the credit score of the service provider from the storage unit 12.

Subsequently, a third notification unit included in the notification unit 17 transmits the credit score of the service provider to the terminal apparatus 21, which is used by the service user, via the network 23. Conceivable examples of the credit score of the service provider include a score that has been generated based on the evaluations made by service users in relation to the service provider.

Thereafter, when the terminal apparatus 21 owned by the service user receives the credit score of the service provider, the credit score of the service provider is displayed in the display of the terminal apparatus 21 of the service user.

The above-described credit score of the service provider is used when, for example, the service user determines whether to use the service. Furthermore, the service user can consider which service provider's service is to be used by referring to credit scores of a plurality of service providers.

Also, the notification unit 17 notifies the service provider of the credit score of the service user. Specifically, first, the notification unit 17 acquires the credit score of the service user from the storage unit 12.

For example, in a case where a service user has made a request to use the service, the service provider makes a request for the provision of the credit score of the service user. Based on this request, the notification unit 17 acquires the credit score of the service user from the storage unit 12.

Subsequently, the notification unit 17 transmits the credit score of the service user to the terminal apparatus 22, which is used by the service provider, via the network 23.

Thereafter, when the terminal apparatus 22 used by the service provider receives the credit score of the service user, the credit score of the service user is displayed in the display of the terminal apparatus 22.

The above-described credit score of the service user is used when, for example, the service provider determines whether to approve the use of the service by the service user at the time of the use of the service by the service user.

At the time of the use of the credit score, it is preferable to gain consent from the service user and the service provider on the provision of the credit score.

### Apparatus Operations

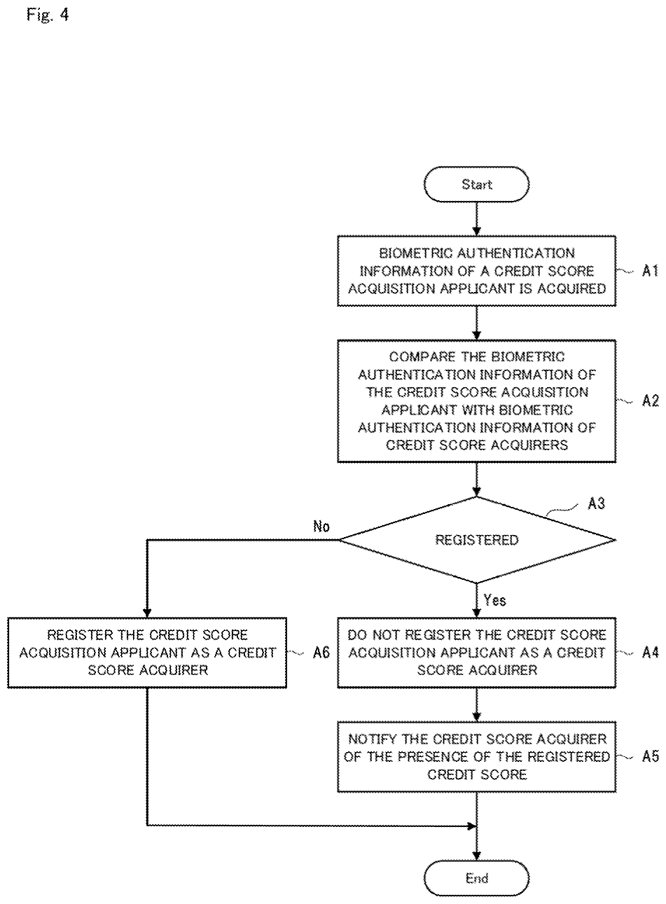

Next, the operations of the credit score management apparatus in the example embodiment of the invention will be described using FIGS. 4, 5, and 6. FIGS. 4, 5, and 6 are diagrams for describing one example of the operations of the credit score management apparatus. In the following description, FIGS. 1 to 3 will be referred to as appropriate. Also, in the example embodiment, a credit score management method is implemented by causing the credit score management apparatus to operate. Therefore, the following description of the operations of the credit score management apparatus applies to the credit score management method in the example embodiment.

A description is now given of registration of a credit score with use of FIG. 4.

As shown in FIG. 4, first, when application for acquisition of a credit score is performed, biometric authentication information of a credit score acquisition applicant is acquired from the terminal apparatus 21 or 22 via the network 23 (step A1).

Subsequently, the registration unit 13 compares the biometric authentication information of the credit score acquisition applicant with biometric authentication information of credit score acquirers (step A2).

Subsequently, in a case where the biometric authentication information of the credit score acquisition applicant has been registered as biometric authentication information of a credit score acquirer (step A3: Yes), the registration unit 13 does not register the credit score acquisition applicant as a new credit score acquirer (step A4).

In a case where the biometric authentication information of the credit score acquisition applicant has been registered as biometric authentication information of a credit score acquirer, the registration unit 13 may register the credit score acquisition applicant as a credit score acquirer with a credit score of the registered credit score acquirer associated therewith as step A4.

Subsequently, in a case where the biometric authentication information of the credit score acquisition applicant has been registered as biometric authentication information of a credit score acquirer, the notification unit 17 notifies the credit score acquirer of the presence of the registered credit score (step A5).

That is to say, in a case where the credit score has already been registered, the notification unit 17 notifies the credit score acquirers (the service user and the service provider, or one of them) or the service mediation system of the presence of the credit score that has already been registered.

For example, a display indicating “there is a credit score that has already been registered” or the like is presented in a display of the terminal apparatus 21 of the service user, the terminal apparatus 22 of the service provider, or both.

Also, in a case where the biometric authentication information of the credit score acquisition applicant has not been registered as biometric authentication information of a credit score acquirer (step A3: No), the registration unit 13 registers the credit score acquisition applicant as a new credit score acquirer (step A6).

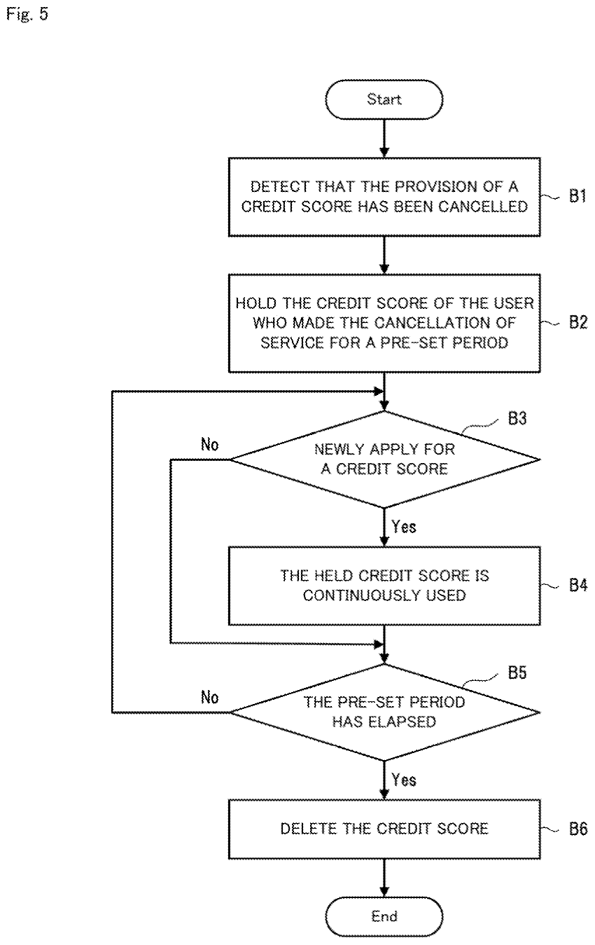

A description is now given of holding of a credit score with use of FIG. 5.

As shown in FIG. 5, first, the holding unit 16 detects that the provision of a credit score has been cancelled (step B1). Subsequently, the holding unit 16 holds the credit score of the user who made the cancellation for a pre-set period (step B2).

Subsequently, in a case where a user who is the same as the user who made the cancellation has newly applied for acquisition of a credit score as a credit score acquisition applicant within the pre-set period (step B3: Yes), the registration unit 13 does not register the credit score acquisition applicant as a new credit score acquirer (step B4). That is to say, as the biometric authentication information of the credit score acquisition applicant is held as biometric information of the credit score acquirer in association with the credit score, the held credit score is continuously used.

Also, in a case where the user who is the same as the user who made the cancellation has not newly applied for acquisition of a credit score (step B3: No), the holding unit 16 executes processing of step B5.

Subsequently, in a case where the pre-set period has elapsed (step B5: Yes), the holding unit 16 deletes the credit score of the user who made the cancellation from the storage unit 12 (step B6). Also, in a case where the pre-set period has not elapsed (step B5: No), processing proceeds to step B3.

Note that in a case where a service business entity that deploys a service manages credit scores, cancellation of the service may be regarded as cancellation of a credit score. In this case, after a service accompanied by the provision of a credit score is cancelled, the holding unit 16 may hold a credit score of a credit score acquirer pertaining to the cancellation of the service for a pre-set period.

Also, in a case where a service business entity that deploys a service manages credit scores, when a pre-set period has elapsed since the cancellation of the service, the holding unit 16 deletes a credit score of a user who cancelled the service from the storage unit 12.

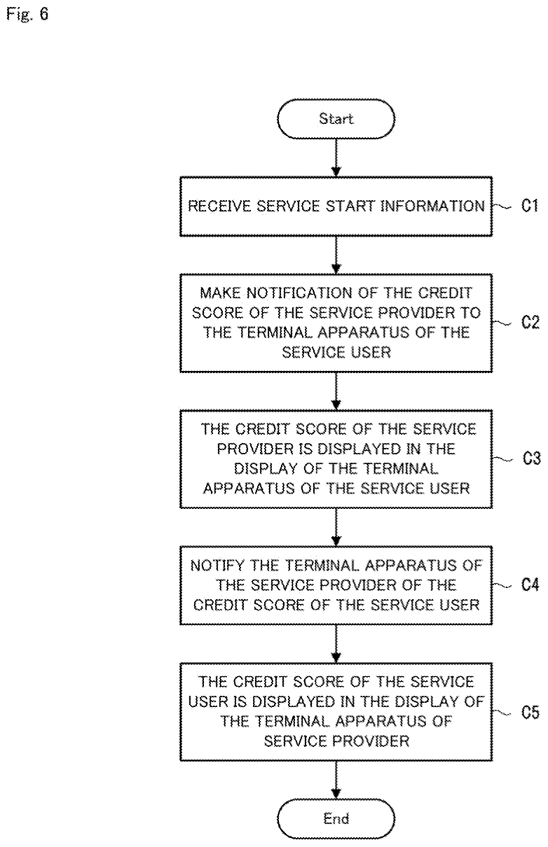

A description is now given of notification of a credit score with use of FIG. 6.

In a case where the biometric authentication information of the credit score acquisition applicant has been registered as biometric authentication information of a credit score acquirer, the first notification unit included in the notification unit 17 makes notification to the terminal of the credit score acquisition applicant that a credit score is present (the fact of being registered as the credit score acquirer).

Also, when the service provider provides a service, or when the service user uses a service, the notification unit 17 notifies its partner or mediator (service mediation system) of the credit score.

As shown in FIG. 6, first, the notification unit 17 receives, from the terminal apparatus 21 of the service user, service start information indicating that the user has started the use of a service (step C1).

Subsequently, the notification unit 17 makes notification of the credit score of the service provider to the terminal apparatus 21 of the service user (step C2). Specifically, in step C2, first, the notification unit 17 acquires the credit score of the service provider from the storage unit 12.

Subsequently, in step C2, the second notification unit included in the notification unit 17 transmits the credit score of the service provider to the terminal apparatus 21, which is used by the service user, via the network 23.

Thereafter, when the terminal apparatus 21 owned by the service user receives the credit score of the service provider, the credit score of the service provider is displayed in the display of the terminal apparatus 21 of the service user (step C3).

Subsequently, the notification unit 17 notifies the service provider of the credit score of the service user (step C4). Specifically, in step C4, first, the notification unit 17 acquires the credit score of the service user from the storage unit 12. Subsequently, in step C4, the third notification unit included in the notification unit 17 transmits the credit score of the service user to the terminal apparatus 22, which is used by the service provider, via the network 23.

Thereafter, when the terminal apparatus 22 used by the service provider receives the credit score of the service user, the credit score of the service user is displayed in the display of the terminal apparatus 22 (step C5).

Note that after step C3, a screen for allowing the service user to select whether to actually determine the use of the service can be displayed in the display of the terminal apparatus 21. Also, after step C5, a screen for allowing the selection of whether to approve the use of the service can be displayed in the display of the terminal apparatus 22.

### Effects of Example Embodiment

As described above, according to the example embodiment, a credit score acquisition applicant is registered as a credit score acquirer in accordance with the result of comparison between biometric authentication information of the credit score acquisition applicant and biometric authentication information of credit score acquirers, and thus the reliability of credit scores can be improved.

Furthermore, in a case where a credit score has already been registered, the credit score acquirers (the service user and the service provider, or one of them) or the service mediation system is notified of the existence of the credit score that has already been registered; this can deter an application for a new credit score.

Also, after the provision of a credit score is cancelled, the credit score of the user who made the cancellation is held for a pre-set period; thus, even if the user who made the cancellation applies again during the pre-set period, the held credit score is associated with the user who made the cancellation, and therefore the held credit score is continuously used. Consequently, the reliability of credit scores can be improved.

In addition, as a result of notifying the service provider of the credit score of the service user, the service provider can refer to the credit score of the service user in judging whether to approve the use of a service by the service user. As a result of notifying the service user of the credit score of the service provider, the service user can refer to the credit score of the service provider in judging whether to use a service of the service provider.

### Program

The program according to an embodiment of the invention may be a program that causes a computer to execute steps A1 to A6 shown in FIG. 4, may be a program that causes a computer to execute steps B1 to B6 shown in FIG. 5, or may be a program that causes a computer to execute steps C1 to C5 shown in FIG. 6. By installing this program in a computer and executing the program, the credit score management apparatus and the credit score management method according to the example embodiment can be realized. In this case, the processor of the computer performs processing to function as the acquisition unit 11, the storage unit 12, the authentication unit 14, the registration unit 13, the generation unit 15, the holding unit 16, and the notification unit 17.

Also, the program according to the embodiment may be executed by a computer system constructed by a plurality of computers. In this case, for example, each computer may function as any of the acquisition unit 11, the storage unit 12, the authentication unit 14, the registration unit 13, the generation unit 15, the holding unit 16, and the notification unit 17.

### Example Modification

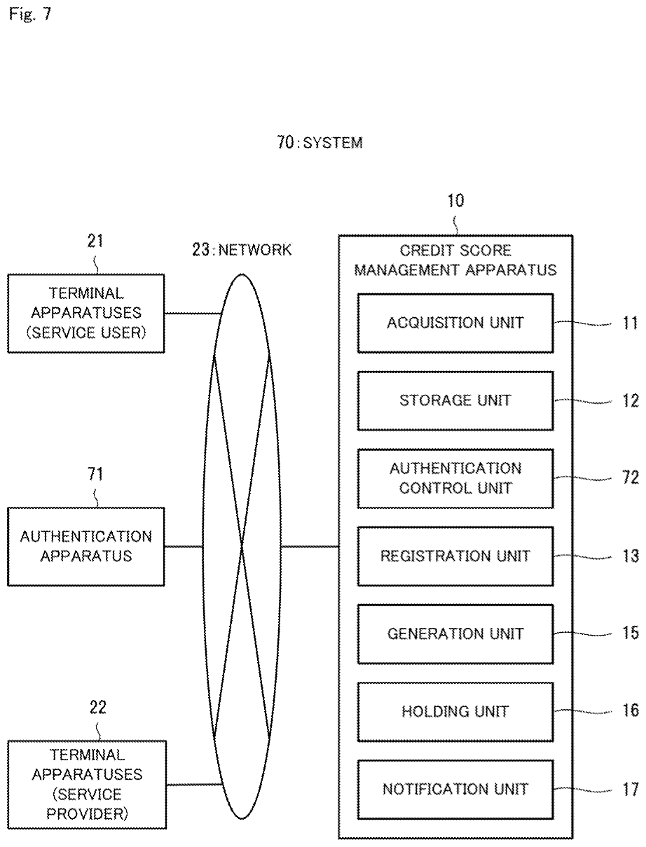

In an example modification, the configuration of a system 70 shown in FIG. 7 may be adopted. FIG. 7 is a diagram for describing one example of a system of the example modification.

In the example modification, as shown in FIG. 7, the system includes an authentication apparatus 71 provided outside the credit score management apparatus 10 and an authentication control unit 72 provided inside the credit score management apparatus 10, in place of the authentication unit 14 shown in FIG. 2.

In the authentication apparatus 71, an ID for the use of a biometric authentication service (first ID) and biometric authentication information are registered in association with each other. Note that, it is assumed that registration with the biometric authentication service is necessary in using a service that provides credit scores.

With use of biometric authentication information of a credit score acquisition applicant acquired by the acquisition unit 11, the authentication apparatus 71 refers to pieces of biometric authentication information that are respectively associated with credit score acquisition applicants, and specifies the credit score acquisition applicant. For example, an ID of the credit score acquisition applicant is specified.

Also, the credit score management apparatus 10 of the example modification does not hold biometric authentication information; an ID and a credit score of a credit score acquirer are registered in association with each other. This ID may be the same ID as the first ID, or may be an ID for the use of a credit score service (second ID). Note that in the latter case, the authentication apparatus 71 manages the first ID and the second ID in correspondence with each other.

A description is now given of the operations in the example modification.

In the example modification, first, the acquisition unit 11 shown in FIG. 7 acquires a shot image (or biometric authentication information) of a credit score acquisition applicant from the credit score acquisition applicant.

Subsequently, the authentication control unit 72 shown in FIG. 7 transmits the acquired captured image, which has been obtained by capturing the credit score acquisition applicant (or the biometric authentication information), to the authentication apparatus 71 via the network 23.

Subsequently, the authentication apparatus 71 shown in FIG. 7 specifies an ID of the credit score acquisition applicant from the biometric authentication information. Thereafter, the authentication apparatus 71 shown in FIG. 7 transmits the specified ID to the credit score management apparatus 10.

Subsequently, in a case where the ID transmitted from the authentication apparatus 71 has already been registered in the storage unit 12, the registration unit 13 shown in FIG. 7 does not register the credit score acquisition applicant as a new credit score acquirer.

Also, in a case where the ID transmitted from the authentication apparatus 71 has not been registered in the storage unit 12 yet, the credit score acquisition applicant is registered as a new credit score acquirer.

### Physical Configuration

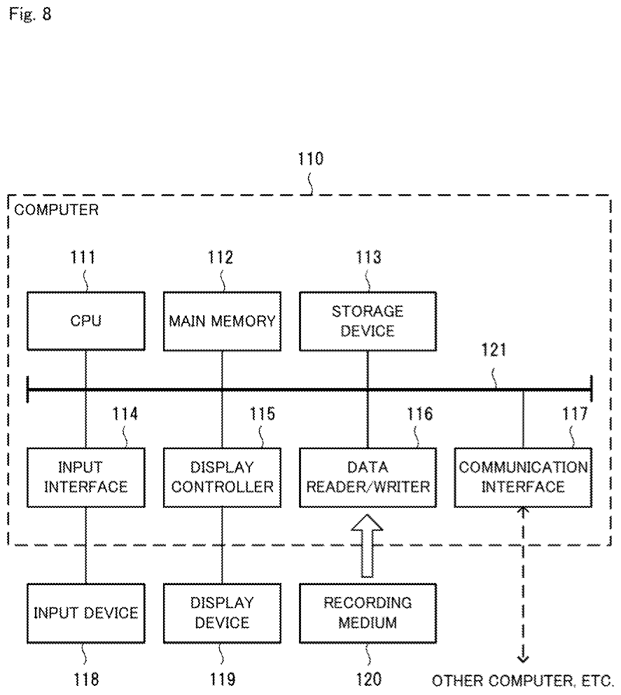

Here, a computer that realizes a credit score management apparatus by executing the program according to an example embodiment will be described with reference to FIG. 8. FIG. 8 is a block diagram showing an example of a computer that realizes the credit score management apparatus according to an example embodiment of the invention.

As shown in FIG. 8, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory). Also, the program according to this example embodiment is provided in a state being stored in a computer-readable recording medium 120. Note that the program according to this example embodiment may be distributed on the Internet, which is connected through the communications interface 117. Note that the recording medium 120 is a non-volatile recording medium.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

Also, instead of a computer in which a program is installed, the credit score management apparatus 10 according to this example embodiment can also be realized by using hardware corresponding to each unit. Furthermore, a portion of the credit score management apparatus 10 may be realized by a program, and the remaining portion realized by hardware.

### Supplementary Notes

Furthermore, the following supplementary notes are disclosed regarding the example embodiments described above. Some portion or all of the example embodiments described above can be realized according to (supplementary note 1) to (supplementary note 21) described below, but the below description does not limit the invention.

### Supplementary Note 1

A credit score management apparatus, comprising:

an acquisition unit configured to acquire biometric authentication information of a credit score acquisition applicant;

a storage unit configured to store a credit score of a credit score acquirer and biometric authentication information of the credit score acquirer in association with each other; and

a registration unit configured to register the credit score acquisition applicant as the credit score acquirer in accordance with a result of comparison between the biometric authentication information of the credit score acquisition applicant and the biometric authentication information of the credit score acquirer.

### Supplementary Note 2

The credit score management apparatus according to supplementary note 1, wherein

in a case where the biometric authentication information of the credit score acquisition applicant has been registered as the biometric authentication information of the credit score acquirer, the registration unit does not register the credit score acquisition applicant as a new credit score acquirer.

### Supplementary Note 3

The credit score management apparatus according to supplementary note 1, wherein

in a case where the biometric authentication information of the credit score acquisition applicant has been registered as the biometric authentication information of the credit score acquirer, the registration unit registers the credit score acquisition applicant as the credit score acquirer with the credit score of the registered credit score acquirer associated therewith.

### Supplementary Note 4

The credit score management apparatus according to supplementary note 2 or 3, further comprising:

a notification unit configured to, in a case where the biometric authentication information of the credit score acquisition applicant has been registered as the biometric authentication information of the credit score acquirer, notifying the credit score acquisition applicant of a presence of the registered credit score.

### Supplementary Note 5

The credit score management apparatus according to any one of supplementary notes 1 to 4, further comprising:

a holding unit configured to hold the credit score of the credit score acquirer for a pre-set period after provision of the credit score is cancelled.

### Supplementary Note 6

The credit score management apparatus according to any one of supplementary notes 1 to 5, further comprising:

a second notification unit configured to, when a service user uses a service of a service provider that holds a credit score, notifying the service user of the credit score held by the service provider.

### Supplementary Note 7

The credit score management apparatus according to any one of supplementary notes 1 to 5, further comprising:

a third notification unit configured to, when a service provider provides a service to a service user who holds a credit score, notifying the service provider of the credit score held by the service user.

### Supplementary Note 8

A credit score management method, comprising:

an acquisition step of acquiring biometric authentication information of a credit score acquisition applicant;

a storage step of storing a credit score of a credit score acquirer and biometric authentication information of the credit score acquirer in association with each other; and

a registration step of registering the credit score acquisition applicant as the credit score acquirer in accordance with a result of comparison between the biometric authentication information of the credit score acquisition applicant and the biometric authentication information of the credit score acquirer.

### Supplementary Note 9

The credit score management method according to supplementary note 8, wherein

in the registration step, in a case where the biometric authentication information of the credit score acquisition applicant has been registered as the biometric authentication information of the credit score acquirer, the credit score acquisition applicant is not registered as a new credit score acquirer.

### Supplementary Note 10

The credit score management method according to supplementary note 9, wherein

in the registration step, in a case where the biometric authentication information of the credit score acquisition applicant has been registered as the biometric authentication information of the credit score acquirer, the credit score acquisition applicant is registered as the credit score acquirer with the credit score of the registered credit score acquirer associated therewith.

### Supplementary Note 11

The credit score management method according to supplementary note 9 or 10, further comprising:

a first notification step for, in a case where the biometric authentication information of the credit score acquisition applicant has been registered as the biometric authentication information of the credit score acquirer, notifying the credit score acquisition applicant of a presence of the registered credit score.

### Supplementary Note 12

The credit score management method according to any one of supplementary notes 8 to 11, further comprising:

a holding step for holding the credit score of the credit score acquirer for a pre-set period after provision of the credit score is cancelled.

### Supplementary Note 13

The credit score management method according to any one of supplementary notes 8 to 12, further comprising:

a second notification step for, when a service user provides a service to a service user who holds a credit score, notifying the service provider of the credit score held by the service user.

### Supplementary Note 14

The credit score management method according to any one of supplementary notes 8 to 12, further comprising:

a third notification step for, when a service provider provides a service to a service user who holds a credit score, notifying the service provider of the credit score held by the service user.

### Supplementary Note 15

A computer readable recording medium that includes a program recorded thereon, the program including instructions that cause a computer to carry out:

an acquisition step of acquiring biometric authentication information of a credit score acquisition applicant;

a storage step of storing a credit score of a credit score acquirer and biometric authentication information of the credit score acquirer in association with each other; and

a registration step of registering the credit score acquisition applicant as the credit score acquirer in accordance with a result of comparison between the biometric authentication information of the credit score acquisition applicant and the biometric authentication information of the credit score acquirer.

### Supplementary Note 16

The computer readable recording medium according to supplementary note 15, wherein

the recorded program further includes instructions that cause the computer to carry out:

in the registration step, in a case where the biometric authentication information of the credit score acquisition applicant has been registered as the biometric authentication information of the credit score acquirer, not registering the credit score acquisition applicant as a new credit score acquirer.

### Supplementary Note 17

The computer readable recording medium according to supplementary note 16, wherein

the recorded program further includes instructions that cause the computer to carry out:

in the registration step, in a case where the biometric authentication information of the credit score acquisition applicant has been registered as the biometric authentication information of the credit score acquirer, registering the credit score acquisition applicant as the credit score acquirer with the credit score of the registered credit score acquirer associated therewith.

### Supplementary Note 18

The computer readable recording medium according to supplementary note 16 or 17, wherein

the recorded program further includes instructions that cause the computer to carry out:

a first notification step of, in a case where the biometric authentication information of the credit score acquisition applicant has been registered as the biometric authentication information of the credit score acquirer, notifying the credit score acquisition applicant of a presence of the registered credit score.

### Supplementary Note 19

The computer readable recording medium according to any one of supplementary notes 15 to 18, wherein

the recorded program further includes instructions that cause the computer to carry out:

a holding step of holding the credit score of the credit score acquirer for a pre-set period after provision of the credit score is cancelled.

### Supplementary Note 20

The computer readable recording medium according to any one of supplementary notes 15 to 19, wherein

the recorded program further includes instructions that cause the computer to carry out:

a second notification step of, when a service user uses a service of a service provider that holds a credit score, notifying the service user of the credit score held by the service provider.

### Supplementary Note 21

The computer readable recording medium according to any one of supplementary notes 15 to 19, wherein

the recorded program further includes instructions that cause the computer to carry out:

a third notification step of, when a service provider provides a service to a service user who holds a credit score, notifying the service provider of the credit score held by the service user.

Although the invention of this application has been described with reference to exemplary embodiments, the invention of this application is not limited to the above exemplary embodiments. Within the scope of the invention of this application, various changes that can be understood by those skilled in the art can be made to the configuration and details of the invention of this application.

### INDUSTRIAL APPLICABILITY

As described above, according to the invention, it is possible to improve the reliability of credit scores. The invention is useful in services of a variety of fields where credit scores are required.

### LIST OF REFERENCE SIGNS

10 Credit score management apparatus
11 Acquisition unit
12 Storage unit
13 Registration unit
14 Authentication unit
15 Generation unit
16 Holding unit
17 Notification unit
20, 70 System
21, 22 Terminal apparatuses
23 Network
71 Authentication apparatus
72 Authentication control unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A credit score management apparatus, comprising:
an acquisition unit configured to acquire biometric authentication information of a credit score acquisition applicant;
a storage unit configured to store a credit score of a credit score acquirer and biometric authentication information of the credit score acquirer in association with each other; and
a registration unit configured to register the credit score acquisition applicant as the credit score acquirer in accordance with a result of comparison between the biometric authentication information of the credit score acquisition applicant and the biometric authentication information of the credit score acquirer.

2. The credit score management apparatus according to claim 1, wherein
in a case where the biometric authentication information of the credit score acquisition applicant has been registered as the biometric authentication information of the credit score acquirer, the registration unit does not register the credit score acquisition applicant as a new credit score acquirer.

3. The credit score management apparatus according to claim 1, wherein
in a case where the biometric authentication information of the credit score acquisition applicant has been registered as the biometric authentication information of the credit score acquirer, the registration unit registers the credit score acquisition applicant as the credit score acquirer with the credit score of the registered credit score acquirer associated therewith.

4. The credit score management apparatus according to claim 2, further comprising:
a first notification unit configured to, in a case where the biometric authentication information of the credit score acquisition applicant has been registered as the biometric authentication information of the credit score acquirer, notifying the credit score acquisition applicant of a presence of the registered credit score.

5. The credit score management apparatus according to claim 1, further comprising:
a holding unit configured to hold the credit score of the credit score acquirer for a pre-set period after provision of the credit score is cancelled.

6. The credit score management apparatus according to claim 1, further comprising:
a second notification unit configured to, when a service user uses a service of a service provider that holds a credit score, notifying the service user of the credit score held by the service provider.

7. The credit score management apparatus according to claim 1, further comprising:
a third notification unit configured to, when a service provider provides a service to a service user who holds a credit score, notifying the service provider of the credit score held by the service user.

8. A credit score management method, comprising:
acquiring biometric authentication information of a credit score acquisition applicant;
storing a credit score of a credit score acquirer and biometric authentication information of the credit score acquirer in association with each other; and
registering the credit score acquisition applicant as the credit score acquirer in accordance with a result of comparison between the biometric authentication information of the credit score acquisition applicant and the biometric authentication information of the credit score acquirer.

9. The credit score management method according to claim 8, wherein
in a case where the biometric authentication information of the credit score acquisition applicant has been registered as the biometric authentication information of the credit score acquirer, the credit score acquisition applicant is not registered as a new credit score acquirer.

10. The credit score management method according to claim 9, wherein
in a case where the biometric authentication information of the credit score acquisition applicant has been registered as the biometric authentication information of the credit score acquirer, the credit score acquisition applicant is registered as the credit score acquirer with the credit score of the registered credit score acquirer associated therewith.

11. The credit score management method according to claim 9, further comprising:
in a case where the biometric authentication information of the credit score acquisition applicant has been registered as the biometric authentication information of the credit score acquirer, notifying the credit score acquisition applicant of a presence of the registered credit score.

12. The credit score management method according to claim 8, further comprising:
holding the credit score of the credit score acquirer for a pre-set period after provision of the credit score is cancelled.

13. The credit score management method according to claim 8, further comprising:
when a service user uses a service of a service provider that holds a credit score, notifying the service user of the credit score held by the service provider.

14. The credit score management method according to claim 8, further comprising:
when a service provider provides a service to a service user who holds a credit score, notifying the service provider of the credit score held by the service user.

15. A non-transitory computer readable recording medium that includes a program recorded thereon, the program including instructions that cause a computer to carry out:
acquiring biometric authentication information of a credit score acquisition applicant;
storing a credit score of a credit score acquirer and biometric authentication information of the credit score acquirer in association with each other; and
registering the credit score acquisition applicant as the credit score acquirer in accordance with a result of comparison between the biometric authentication information of the credit score acquisition applicant and the biometric authentication information of the credit score acquirer.

16. The non-transitory computer readable recording medium according to claim 15, wherein
the recorded program further includes instructions that cause the computer to carry out:
in a case where the biometric authentication information of the credit score acquisition applicant has been registered as the biometric authentication information of the credit score acquirer, not registering the credit score acquisition applicant as a new credit score acquirer.

17. The non-transitory computer readable recording medium according to claim 16, wherein
the recorded program further includes instructions that cause the computer to carry out:
in a case where the biometric authentication information of the credit score acquisition applicant has been registered as the biometric authentication information of the credit score acquirer, registering the credit score acquisition applicant as the credit score acquirer with the credit score of the registered credit score acquirer associated therewith.

18. The non-transitory computer readable recording medium according to claim 16, wherein
the recorded program further includes instructions that cause the computer to carry out:
in a case where the biometric authentication information of the credit score acquisition applicant has been registered as the biometric authentication information of the credit score acquirer, notifying the credit score acquisition applicant of a presence of the registered credit score.

19. The non-transitory computer readable recording medium according to claim 15, wherein
the recorded program further includes instructions that cause the computer to carry out:
holding the credit score of the credit score acquirer for a pre-set period after provision of the credit score is cancelled.

20. The non-transitory computer readable recording medium according to claim 15, wherein
the recorded program further includes instructions that cause the computer to carry out:
when a service user uses a service of a service provider that holds a credit score, notifying the service user of the credit score held by the service provider.

21. (canceled)
